(19) United States
(12) Patent Application Publication
(10) Pub. No.: US 2013/0037685 A1
(43) Pub. Date: Feb. 14, 2013

(54) WINDOW CANDLE HOLDER

(71) Applicant: Edward Hall, Toano, VA (US)

(72) Inventor: Edward Hall, Toano, VA (US)

(21) Appl. No.: 13/207,200

(22) Filed: Aug. 10, 2011

(51) Int. Cl. F21V 35/00

(52) U.S. Cl. 248/539

(57) ABSTRACT

An improved candle restraining means where the candle restraining means is comprised of a generally flat, semi-flexible structure. The restraining means has a collar portion with an aperture to accept a candle shaft, and a generally horizontal portion that extends under, and is secured by, a closed window. The horizontal portion has an angled portion that is compressed against the horizontal portion when the device is in use, providing secure restraint for a candle on a window sill.

### BACKGROUND OF THE INVENTION

1. Field of the Invention

The present invention relates to the field of window candles, and more particularly to a device for supporting window candles in their upright vertical position on a window sill.

2. Background and Description of the Prior Art

Window candles are used for their aesthetic appeal. They are used at various times of the year and for various reasons, but the most common use of window candles is for holidays. For example, the fall and winter holidays of Halloween, Thanksgiving, Hanukkah, Christmas are commonly associated with the use of candles in window sills. The candles are placed in the window sills to project a festive or holiday atmosphere to outside of a home, and are positioned so that the candles are visible through the windows of a structure.

However, candles and candle bases can be unsteady on a window sill. This is due to a combination of a candle and base being generally tall and slender, with a small base to height ratio. In addition, cords for electric candles can create a pulling force that can make it difficult to have a candle remain upright. The electric cords for such candles are also frequently disturbed by people moving around the window, causing the candles to fall over or completely off of the window sill. In addition, many window sills are narrow, increasing the likelihood that a candle will fall over or off of the window sill.

There is prior art know that attempts to solve this problem.

U.S. Pat. No. 4,392,191 to White discloses a window stabilizer for a candle assembly wherein an l-shaped stabilizer fits around the shaft of a candle and has a portion that inserts into the space between the window and the sill, but does not extend underneath the window, allowing the candle and holder to move from side to side relative to the window; in this manner the candle may move out of vertical alignment or fall over altogether.

U.S. Pat. No. Des. 320,864 to Boschetto discloses an ornamental design for a “window mounted electric candle or similar article.” The Boschetto design, however, provides for a deep vertical support member that can, similarly to the White design, move from side to side. In addition, the Boschetto invention has no additional means for securing the holder under a closed window.

U.S. Pat. No. 4,468,721 to Vandrilla shows a candle assembly incorporating a leash for supporting the candle. The Vandrilla invention, however, teaches a holder that extends out beyond the exterior of the window frame when closed, leaving spaces and potentially gaps where the window could allow in water, bugs, and drafts. Further, the Vandrilla invention is extremely thin and flexible, sacrificing stability for the candle and allowing the candle to potentially fall over, creating a hazard.

What is needed is a holder for candles that is 1) broad and stable, providing for a secure means of keeping a candle (whether electric or otherwise) in place on a window sill; 2) comprised of thin material such that there is not an excessive gap between the bottom of the window and the sill; 3) does not extend to the exterior of the window structure; and 4) provides for additional means to secure the candle so that additional mechanical restraint is provided without sacrificing the versatility and the thinness of the candle holder.

### SUMMARY OF THE INVENTION

The present invention is a device for holding candles on window sills so that the candle is kept securely in place, is visible from outside of the window, and does not create a significant spacing or gap under the window to allow in inclement weather (i.e., rain or moisture) or create significant flow of outside air into or out of a house. Further, modem windows generally include a ridge running down the center line of the bottom of the window frame, the ridge extending horizontally upward into the window sash when the window is closed, enhancing the air- and water-tightness of the window seal.

A preferred embodiment of the present invention includes a generally flat portion of plastic or other flexible material with a portion through which a candle stem may be inserted by means of an aperture or hole. The embodiment further comprises a horizontally extending portion that is insertable under a window and thence the window closed down onto the horizontally extending portion.

In another preferred embodiment, the present invention is comprised of a flexible material that bends over the top of a ridge on the window frame, the ridge extending into a recessed portion of the window sash, and the present invention bending to allow complete closure of the window.

In another preferred embodiment, the horizontally extending portion further comprises an angled portion that extends back from the end of the horizontal portion towards the portion through which the candle is inserted. The angled portion that extends back is shorter than the horizontal portion that extends under a window, and is formed such that the angled portion, while not under pressure or compressed by the closing of a window on top of the device portion under a window rests at an angle above the horizontal portion. While in use, the angled portion is compressed under the window, between the window and the window sill, such that an upward mechanical force is exerted on the bottom of the window. This upward force serves to add greater restraining force while the device is being used to secure a candle on a window sill.

### DESCRIPTION OF THE DRAWINGS

FIG. 1 is a side view of the invention while in use.

FIG. 2(a) is a perspective view of the present invention while not in use.

FIG. 2(b) is a side view of the present invention while not in use.

FIG. 3 is a view of an embodiment of the present invention extending through an open window.

### DESCRIPTION OF A PREFERRED EMBODIMENT

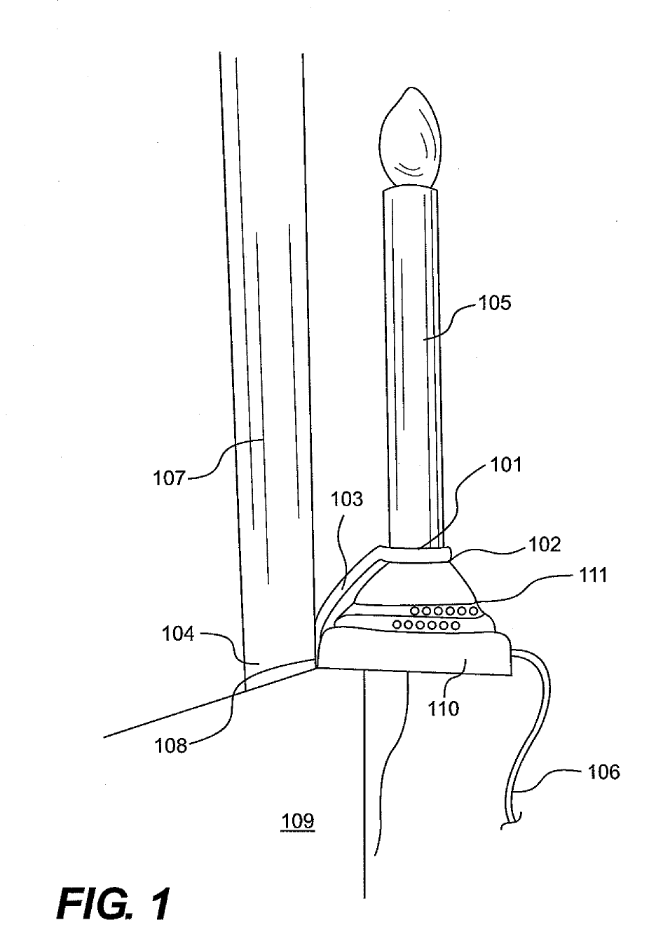

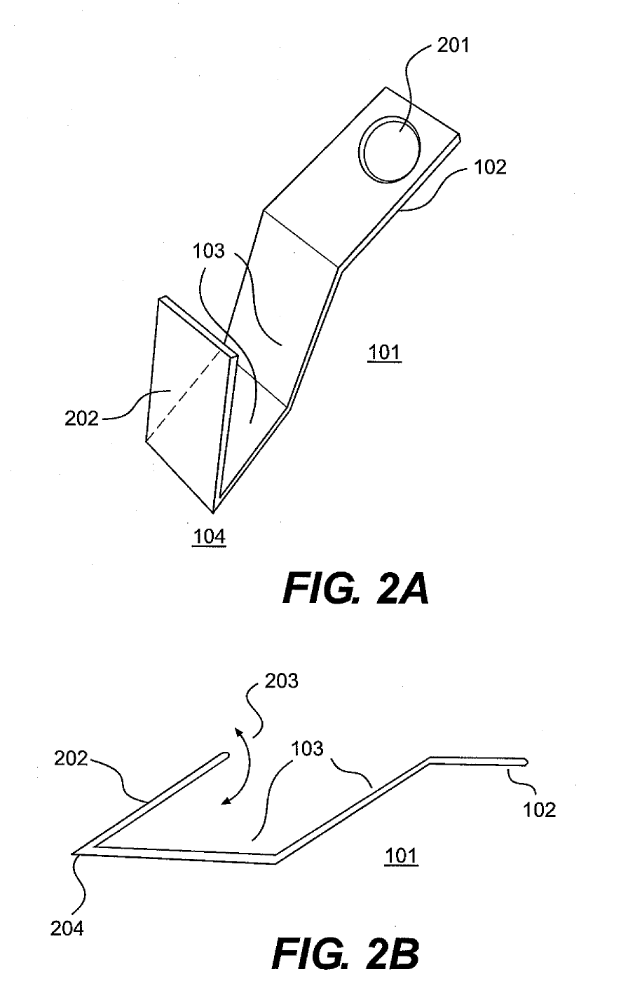

Referring now to FIG. 1, a candle restraining device 101 is shown in accordance with an embodiment of the present invention. The device 101 is shown with a collar portion 102, a horizontal portion 103, and a restraining portion 104. The restraining portion 104 comprises an extension of the horizontal portion 103 and an angled portion (shown in FIG. 2(a) and FIG. 2(b)). While in use, the shaft of a candle 105 is inserted through an aperture (show in FIG. 2(a) and FIG. 2(b)) in the collar portion 102. The horizontal portion 103 extends under a window 107, with the restraining portion 104 resting under the bottom edge 108 of the window 107. The window 107 rests upon a structure 109, which has a sill 110 that extends outwards horizontally from the structure 109 into the interior of a house or other building. The base of the candle 105 rests on the sill 110. Also shown is the electrical cord 106 for the candle. It will be understood by those skilled in the art that the candle 105 may be electric or naturally-burning without deviating from the scope of this invention.

Referring now to FIG. 2(a), the present invention is shown in perspective view while not in use. Shown are the device 101 with the collar portion 102, horizontal portion 103, and the restraining portion 104. An aperture 201 extends through the collar portion 102, allowing a candle (as show in FIG. 1) to be inserted through the collar portion 102. The restraining portion 104 comprises an extension of the horizontal portion 103 and an angled portion 202.

Referring now to FIG. 2(b), a side view of the present invention is shown while not in use. The device 101 shows the collar portion 102, the generally horizontal portion 103, and the angled portion 202. It will be clear from the FIG. 2(b) that the angled portion 202 is moveable 203 about the hinge portion 204. As a window is closed on the device 101, the angled portion 202 is compressed downward towards the generally horizontal portion 103. The hinge portion 204 is created by forming the angled portion 202 as shown in relation to the horizontal portion 103 during the manufacturing process. The invention is preferably molded or crafted from semi-rigid materials such as plastics that allow the necessary bending at the hinge 204, although it will be understood by those skilled in the art that the angled portion may be formed after the device 101 is manufactured.

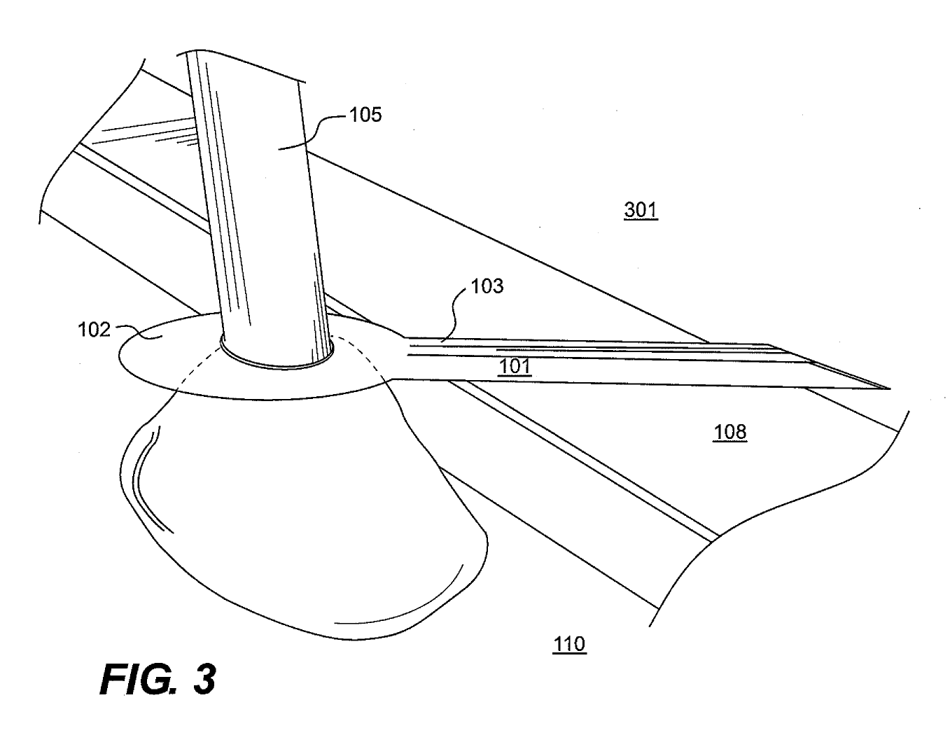

Referring now to FIG. 3, the present invention is shown extending straight through an open window 301.

The invention herein has been described in detail, and in light of the FIGS. 1, 2(a) and 2(b), and 3. It will be understood, however, that the description herein is not intended to be limiting, and variations in materials and configuration of the invention may be made without exceeding the scope of the invention.

1-5. (canceled)

6. A candle holder for holding and supporting a candle, comprising:
a collar portion;
an aperture within the collar portion;
a horizontal portion.

7. The candle holder of claim 1 wherein the wherein the aperture within the collar portion is placed around the shaft of a candle, and the horizontal portion extends through a window opening, wherein the window comprises a window sash and a window frame, and the window opening is created between the window sash and the bottom edge of the window frame when the window is open.

8. The invention of claim 2 wherein the window further comprises a window sill that is located to the interior of a structure, and the candle is positioned on the window sill.

9. The invention of claim 1 wherein the candle holder is comprised of a flexible, plastic material.

10. The invention of claim 2 wherein the candle holder is comprised of a flexible, plastic material and the window further comprises a vertical ridge on the bottom edge of the window frame and a corresponding recess in the bottom of the window sash, and wherein the flexible, plastic material allows the candle holder to conform to the shape of the interface between the window sash and the window frame when the window is closed.
